(19) United States
(12) Patent Application Publication
(10) Pub. No.: US 2026/0084552 A1
(43) Pub. Date: Mar. 26, 2026

(54) CHARGE PORT DOOR SYSTEM

(71) Applicants: Hyundai Motor Company, Seoul (KR); Kia Corporation, Seoul (KR); PHA Co., Ltd., Daegu (KR)

(72) Inventors: Sang Il Kim, Hwaseong-si (KR); Kyung Min Lee, Hwaseong-si (KR)

(21) Appl. No.: 19/089,756

(22) Filed: Mar. 25, 2025

(30) Foreign Application Priority Data
Sep. 24, 2024 (KR) 10-2024-0129277

(51) Int. Cl. B60L 53/16; E05F 15/622

(52) U.S. Cl. CPC B60L 53/16; E05F 15/622; E05Y 2900/534

(57) ABSTRACT

A charge port door system can include a housing, a door configured to rotate between a cover position in which the door covers the housing and an open rotated uncover position in which the door uncovers the housing and is not blocking access to the housing, a door actuator fixed to the door, the door actuator including an outer actuator member configured to linearly move and rotate by a motor, and an inner actuator member releasably engaged to the outer actuator member by a friction fastener, and a guide housing fixed to the housing, the guide housing being configured to receive the outer actuator member such that a motion of the door via the outer actuator member is guided by an engagement of a guide protection of the guide housing with straight and spiral grooves in the outer actuator member.

### CROSS-REFERENCE TO RELATED APPLICATIONS

This application is based on and claims the benefit of priority to Korean Patent Application No. 10-2024-0129277, filed on Sep. 24, 2024, in the Korean Intellectual Property Office, the disclosure of which is incorporated herein in its entirety by reference.

### TECHNICAL FIELD

The present disclosure relates to a charge port door system.

### BACKGROUND

An electric vehicle (EV) and a hybrid electric vehicle (HEV) may include a charge port for connecting an electric plug (charging plug) to the vehicle. The electric plug may be connected to a charging station supplying power to the vehicle. In addition, the EV and the HEV may include a charge port door system covering and uncovering the charge port.

The charge port door system may include a housing having an opening communicating with the charge port, a door movably mounted with respect to the housing, and an actuator configured to move the door. Types of the charge port door system according to the related art may include a gooseneck hinge-type charge port door system, a multilink-type charge port door system, and the like.

However, the related art charge port door system may fail to reliably open and close the door in a narrow space, which degrades the operability of the door. In a state in which the door is opened, the charging plug may interfere with the door, resulting in reduced product quality or marketability.

In addition, the related art charge port door system may have difficulty in opening and closing the door in an emergency condition such as battery discharge and a failure of the actuator, which makes it difficult to quickly charge the battery.

The above information described in this background section is provided to assist in understanding the background of the present disclosure, and may include technical information that is not considered as the prior art that is already publicly known, available, or in use.

### SUMMARY

The present disclosure relates to a charge port door system, and more particularly, to a charge port door system designed to automatically and/or manually open and close a door under various conditions, thereby reliably performing the opening and closing of the door.

An embodiment of the present disclosure can solve the above-mentioned problems occurring in the prior art while advantages achieved by the prior art are maintained intact.

An embodiment of the present disclosure can provide a charge port door system designed to automatically and/or manually open and close a door under various conditions, thereby reliably performing the opening and closing of the door, and preventing a charging plug from interfering with the door in a state in which the door is opened.

According to an embodiment of the present disclosure, a charge port door system may include: a housing; a door configured to rotate between a cover position in which the door covers the housing and an uncover position in which the door uncovers the housing, and to move between a retracted position in which the door comes into contact with the housing and an advanced position in which the door is advanced from the housing in a state in which the door is in the cover position; a door actuator fixed to the door, and including an outer actuator member configured to linearly move and rotate by a motor, and an inner actuator member releasably engaged to the outer actuator member by a friction fastener; and a guide housing fixed to the housing, and configured to receive the outer actuator member. The outer actuator member may include a first guide groove extending straightly along a longitudinal direction thereof, and a second guide groove extending spirally from the first guide groove, and the first guide groove and the second guide groove may be provided in an outer surface of the outer actuator member. The guide housing may have a guide projection received in the first guide groove and the second guide groove.

The door actuator may further include a lead screw rotated by the motor. The lead screw may have an external thread on an outer peripheral surface thereof, and the inner actuator member may have an internal thread meshing with the external thread of the lead screw.

The friction fastener may be press-fitted between an outer surface of the inner actuator member and an inner surface of the outer actuator member. The friction fastener may have a projection frictionally engaged to the inner surface of the outer actuator member.

The friction fastener may include a corrugated metal strip, and a polymer layer attached to an outer surface of the metal strip. The polymer layer may frictionally contact the inner surface of the outer actuator member, and the metal strip may frictionally contact the outer surface of the inner actuator member.

The polymer layer may have a coefficient of friction lower than that of the metal strip.

The outer actuator member may include an attachment portion fixed to the door.

The outer actuator member may be configured to move between a first position, a second position, and a third position. The door may be in the retracted position when the outer actuator member is in the first position, the door may be in the advanced position when the outer actuator member is in the second position, and the door may be in the uncover position when the outer actuator member is in the third position.

When the outer actuator member moves between the first position and the second position, the outer actuator member may be linearly guided by the first guide groove and the guide projection, and when the outer actuator member moves between the second position and the third position, the outer actuator member may be guided to rotate around a central axis thereof by the second guide groove and the guide projection.

The door actuator may further include an actuator housing receiving the motor, and a guide sleeve extending from the actuator housing toward the door. The guide sleeve may be received in the guide housing, and the outer actuator member may be movably received in the guide sleeve.

The outer surface of the outer actuator member may be configured to match an inner surface of the guide sleeve.

The guide housing may include a cylindrical portion receiving the guide sleeve, an attachment plate provided on the cylindrical portion, and a plurality of bosses provided on the attachment plate. The plurality of bosses may be fixed to the door through a plurality of fasteners.

The door actuator may further include a transmission mechanism configured to transmit a torque of the motor to the lead screw.

The door actuator may further include an operating gear configured to transmit the torque from the transmission mechanism to the lead screw.

The operating gear may be fixed to the lead screw.

The door actuator may further include a sensor configured to sense a position of the outer actuator member to detect a position of the door.

### BRIEF DESCRIPTION OF THE DRAWINGS

The above and other features and advantages of the present disclosure can be more apparent from the following detailed description taken in conjunction with the accompanying drawings:

FIG. 1 illustrates an exploded perspective view of a door and a housing in a charge port door system according to an example embodiment of the present disclosure, which is viewed from the outside of a vehicle;

FIG. 2 illustrates a housing of a charge port door system according to an example embodiment of the present disclosure, which is viewed from the outside of a vehicle;

FIG. 3 illustrates a housing of a charge port door system according to an example embodiment of the present disclosure, which is viewed from the interior of a vehicle;

FIG. 4 illustrates an exploded perspective view of a door in a charge port door system according to an example embodiment of the present disclosure;

FIG. 5 illustrates a perspective view of a guide housing in a charge port door system according to an example embodiment of the present disclosure;

FIG. 6 illustrates an exploded perspective view of an outer actuator member and an inner actuator member in a charge port door system according to an example embodiment of the present disclosure;

FIG. 7 illustrates a view, which is viewed in the direction of arrow A of FIG. 6;

FIG. 8 illustrates an exploded perspective view of a door actuator in a charge port door system according to an example embodiment of the present disclosure;

FIG. 9 illustrates a side cross-sectional view of a door actuator in a charge port door system according to an example embodiment of the present disclosure;

FIG. 10 illustrates a cross-sectional view, taken along line B-B of FIG. 9;

FIG. 11 illustrates a cross-sectional view, taken along line C-C of FIG. 9;

FIG. 12 illustrates a state in which an actuator member is in a first position in a charge port door system according to an example embodiment of the present disclosure;

FIG. 13 illustrates a cross-sectional view, taken along line D-D of FIG. 12;

FIG. 14 illustrates a state in which an actuator member is in a second position in a charge port door system according to an example embodiment of the present disclosure;

FIG. 15 illustrates a state in which an actuator member is in a third position in a charge port door system according to an example embodiment of the present disclosure;

FIG. 16 illustrates a state in which a door is closed by a backward movement of an actuator member in a charge port door system according to an example embodiment of the present disclosure;

FIG. 17 illustrates a view, which is viewed in the direction of arrow E of FIG. 16;

FIG. 18 illustrates a state in which a door is advanced from a housing by a forward movement of an actuator member in a charge port door system according to an example embodiment of the present disclosure;

FIG. 19 illustrates a state in which a door is rotated toward the outside of a housing by a rotation of an actuator member in a charge port door system according to an example embodiment of the present disclosure; and

FIG. 20 illustrates a view, which is viewed in the direction of arrow F of FIG. 19.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. A detailed description of well-known techniques associated with the present disclosure can be omitted to not unnecessarily obscure the gist of the present disclosure.

Terms such as “first,” “second,” “A,” “B,” “(a),” and “(b)” may be used to describe elements in example embodiments of the present disclosure. These terms can be used merely to distinguish one element from another element, and the intrinsic features, sequence or order, and the like of the corresponding elements are not necessarily limited by these terms. Unless otherwise defined, terms used herein, including technical or scientific terms, can have same meanings as those generally understood by those with ordinary knowledge in the field of art to which the present disclosure belongs. Such terms as those defined in a generally used dictionary can be interpreted as having meanings equal to the contextual meanings in the relevant field of art.

A charge port door system 10 may be configured to cover and uncover a charge port of a vehicle. The charge port may be configured to connect an electric plug (charging plug) to the vehicle (an electric vehicle (EV), a hybrid electric vehicle (HEV), and the like), and the electric plug may be connected to a charging station supplying power to the vehicle. The charge port door system 10 may be mounted in an opening of a vehicle body where the charge port is disposed, and the charge port door system 10 may have an exterior surface facing the exterior of the vehicle, and an interior surface facing the interior of the vehicle.

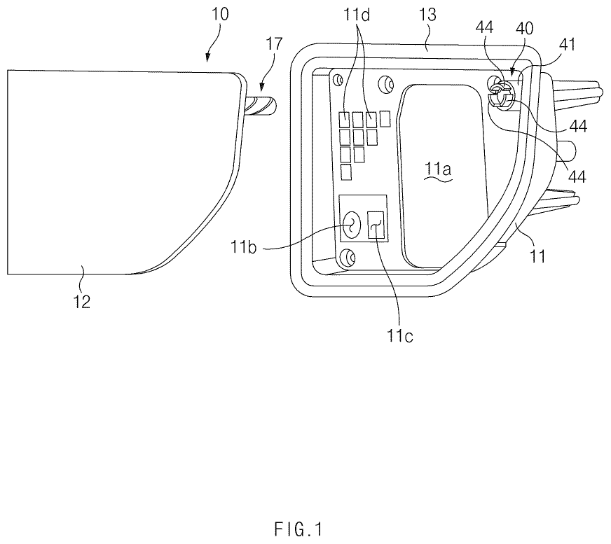

Referring to FIG. 1, the charge port door system 10 according to an example embodiment of the present disclosure may include a housing 11, and a door 12 which is movable relative to the housing 11.

The housing 11 may be disposed to enclose the charge port (not shown) of the vehicle. The housing 11 may have an exterior surface facing the exterior of the vehicle, and an interior surface facing the interior of the vehicle. When the door 12 is closed, the exterior surface of the housing 11 may be covered by the door 12, and when the door 12 is opened, the exterior surface of the housing 11 may be exposed to the outside of the vehicle.

The housing 11 may have a shape of a container recessed toward the interior of the vehicle. Referring to FIG. 1, the housing 11 may have a main opening 11a communicating with the charge port (not shown). The housing 11 may have a plurality of button openings 11b and 11c and a plurality of LED openings 11d. A seal 13 may extend along edges of the housing 11, and the seal 13 may seal edges of the door 12 and the edges of the housing 11 when the door 12 is closed.

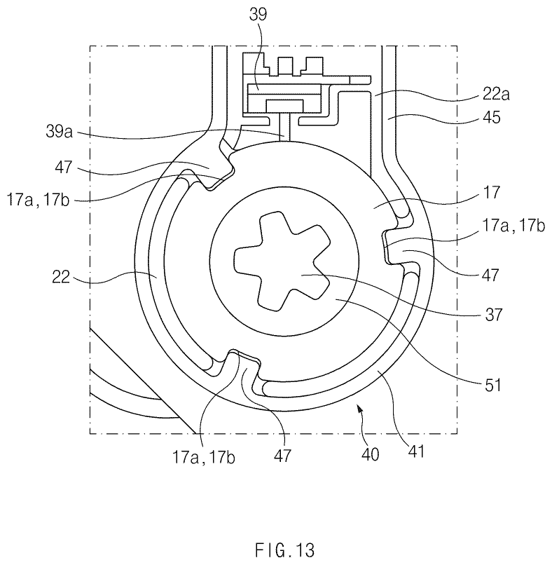

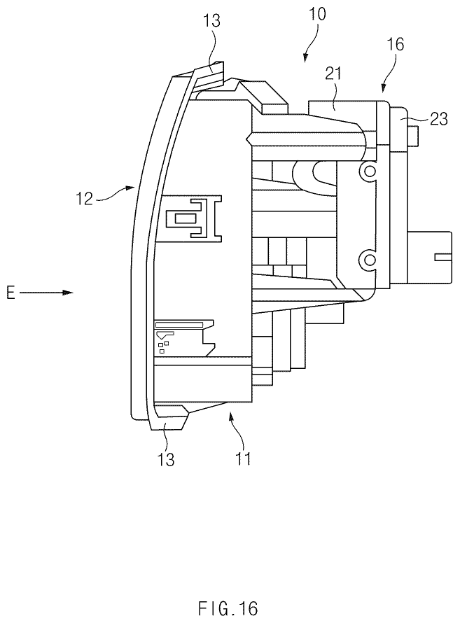

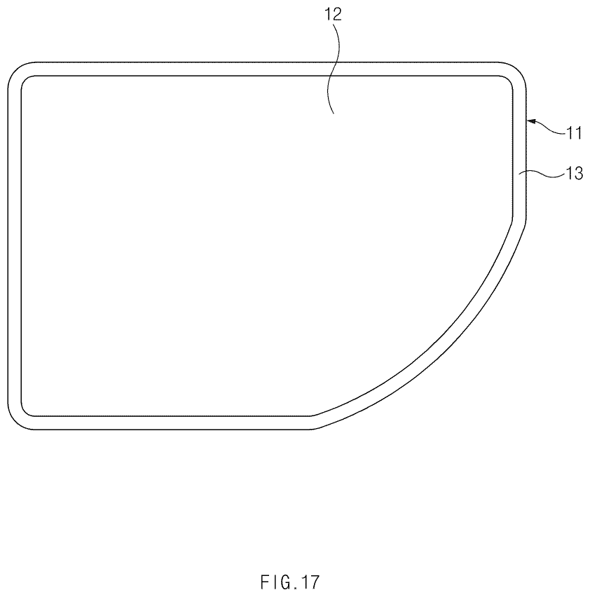

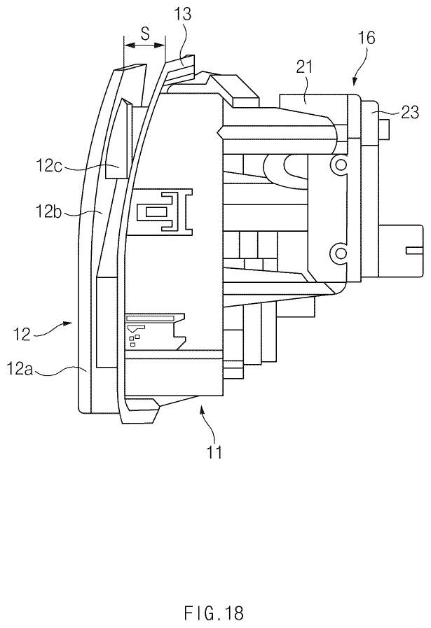

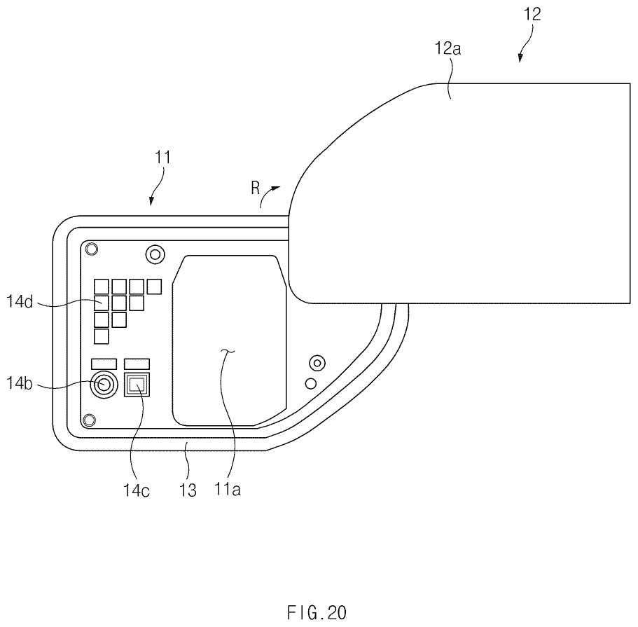

FIGS. 1-20 show various views and configurations of an example embodiment of the present disclosure, as described next. The door 12 may be configured to rotate by a door actuator 16 between a cover position (see FIG. 17) in which the door 12 covers the housing 11 and an uncover position (see FIG. 20) in which the door 12 uncovers the housing 11. When the door 12 is in the cover position, the door 12 may be configured to move linearly by the door actuator 16 between a retracted position (see FIG. 16) and an advanced position (see FIG. 18). Referring to FIG. 16, the retracted position refers to a position in which the door 12 comes into contact with the housing 11. Referring to FIG. 18, the advanced position refers to a position in which the door 12 is advanced from the housing 11 toward the outside of the vehicle so that the door 12 may be spaced apart from the housing 11 by a predetermined distance S.

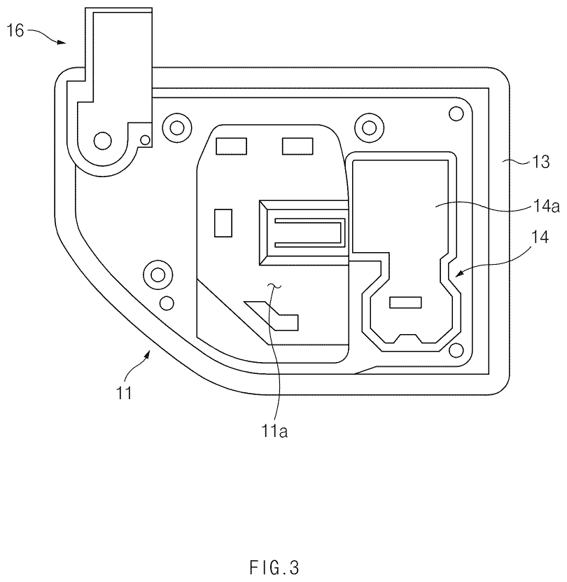

The charge port door system 10 according to an example embodiment of the present disclosure may include the door actuator 16 configured to move the door 12, and a switch assembly 14 configured to control/adjust the operation of the door actuator 16. Referring to FIG. 3, the switch assembly 14 and the door actuator 16 may be mounted on the interior surface of the housing 11.

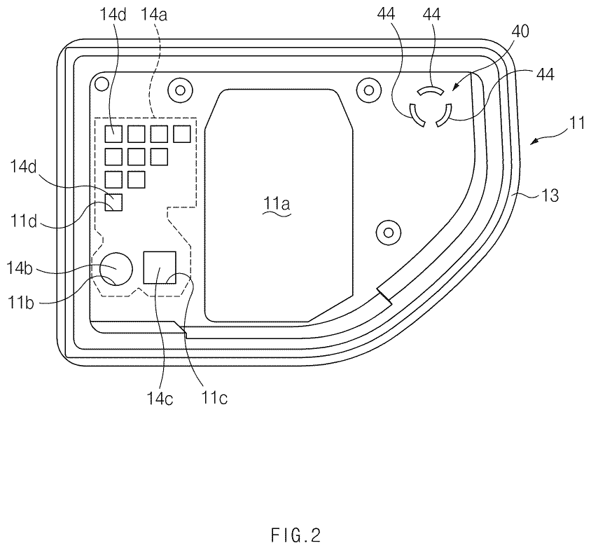

The switch assembly 14 may be electrically connected to the door actuator 16 to be described below and a battery of the vehicle. Referring to FIGS. 2 and 3, the switch assembly 14 may have a switch housing 14a, and a plurality of buttons 14b and 14c and a plurality of LEDs 14d provided on the switch housing 14a. The plurality of buttons 14b and 14c may include an opening button 14b for controlling the opening of the door 12 and a closing button 14c for controlling the closing of the door 12. The plurality of buttons 14b and 14c may be inserted into the button openings 11b and 11c of the housing 11, respectively, and the plurality of LEDs 14d may be inserted into the LED openings 11d of the housing 11, respectively. In a state in which the door 12 is opened, a user may directly press each of the buttons 14b and 14c so that the switch assembly 14 may be turned on. In a state in which the door 12 is closed, the user may partially press a portion of the door 12 corresponding to each of the buttons 14b and 14c, and accordingly each of the buttons 14b and 14c may be indirectly pressed through the door 12 so that the switch assembly 14 may be turned on. The plurality of LEDs 14d may be configured to display the charge amount and charge state of the vehicle battery.

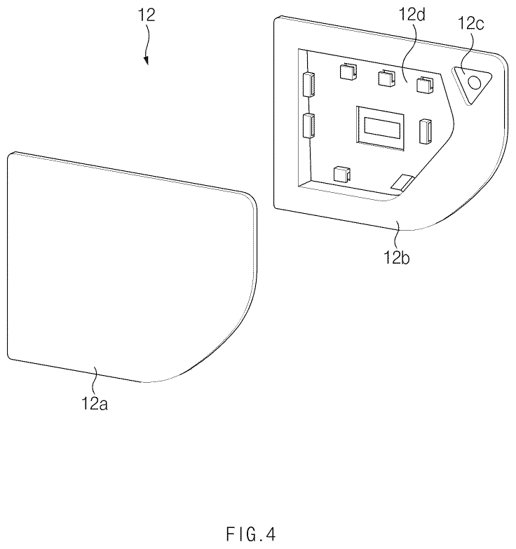

Referring to FIG. 4, the door 12 may include an outer panel 12a, and an inner panel 12b fixed to an interior surface of the outer panel 12a. The outer panel 12a may face the outside of the vehicle, and the inner panel 12b may face the interior of the vehicle. The outer panel 12a may be detachably attached to the inner panel 12b by a plurality of snap-fittings. A mounting portion 12c and a recessed portion 12d may be recessed from the inner panel 12b toward the housing 11.

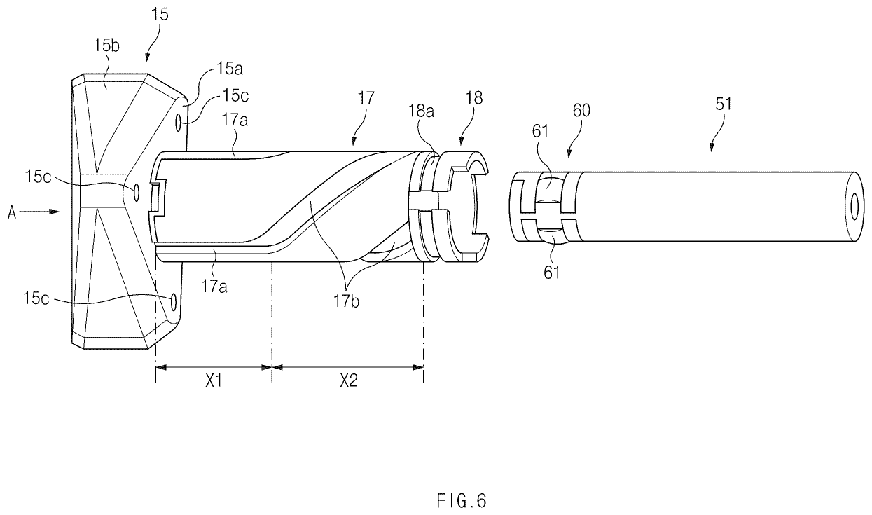

Referring to FIG. 6, the door actuator 16 may include an outer actuator member 17 moving the door 12, and an inner actuator member 51 releasably engaged to the inside of the outer actuator member 17 by a friction fastener 60.

The outer actuator member 17 may have a cavity extending along a central longitudinal axis thereof. The outer actuator member 17 may extend through one edge of the housing 11 and be fixed to one edge of the door 12. The outer actuator member 17 may be configured to linearly move and rotate so that the door 12 may be advanced or retracted and rotate with respect to the housing 11. The outer actuator member 17 may include a first end portion facing the exterior of the vehicle, and a second end portion facing the interior of the vehicle. According to an example embodiment, the outer actuator member 17 may be made of an aluminum die-cast material, and accordingly stiffness of the outer actuator member 17 may be improved.

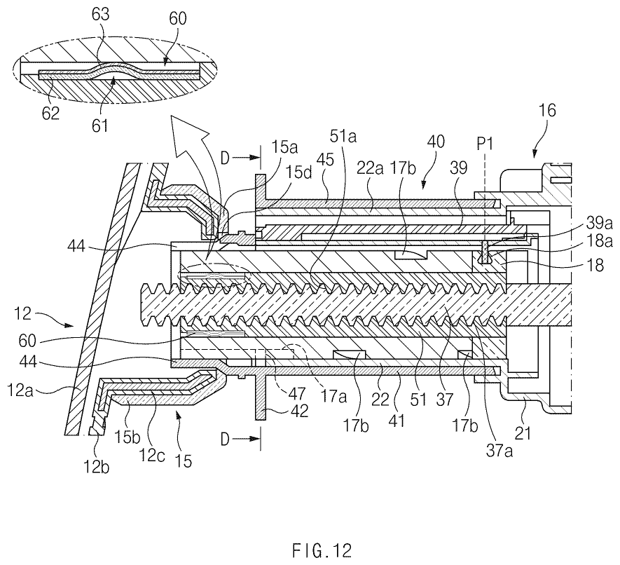

Referring to FIG. 6, the outer actuator member 17 may include an attachment portion 15 integrally connected to the first end portion thereof. The attachment portion 15 may be made of the same material as that of the outer actuator member 17, and the attachment portion 15 and the outer actuator member 17 may form a unitary one-piece structure. The attachment portion 15 of the outer actuator member 17 may be fixed to the door 12 through a fastener. Referring to FIGS. 12, 14, and 15, the attachment portion 15 may be fixed to the mounting portion 12c of the inner panel 12b of the door 12. The attachment portion 15 may include an attachment wall 15a integrally formed with the first end portion of the outer actuator member 17, and sidewalls 15b connected to edges of the attachment wall 15a. The attachment wall 15a may have a plurality of holes 15c, and a plurality of fasteners (screws and the like) may be screwed into the plurality of holes 15c, respectively, so that the attachment wall 15a of the attachment portion 15 may be fixed to the mounting portion 12c of the inner panel 12b of the door 12, and the sidewalls 15b of the attachment portion 15 may encompass sidewalls of the mounting portion 12c of the inner panel 12b. Accordingly, the attachment portion 15 of the outer actuator member 17 may be fixed to the mounting portion 12c of the inner panel 12b of the door 12 through the plurality of holes 15c. The outer actuator member 17 may be firmly fixed to the door 12 through the attachment portion 15 so that vibration, shaking, damage, and the like of the door 12 may be prevented while the door 12 is moving.

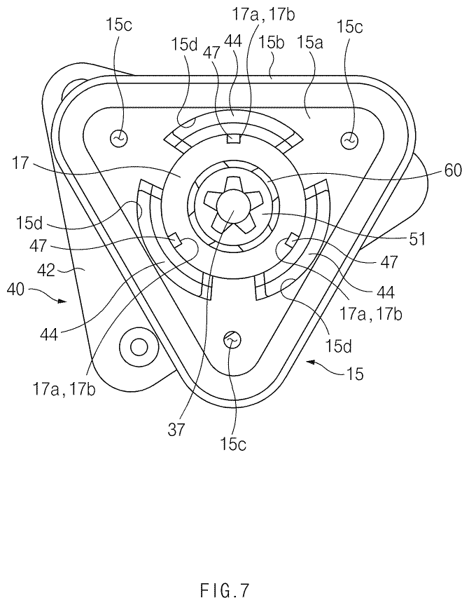

Referring to FIG. 7, the attachment portion 15 may have a plurality of openings 15d, each opening 15d may have an arc shape, and an inner peripheral surface of each opening 15d may be aligned with an outer peripheral surface of the outer actuator member 17. The plurality of openings 15d may be spaced apart from each other in a circumferential direction of the outer actuator member 17.

Referring to FIG. 6, the outer actuator member 17 may include a first guide groove 17a extending straightly along the longitudinal axis of the outer actuator member 17, and a second guide groove 17b extending spirally from the first guide groove 17a. The first guide groove 17a may extend straightly from the first end portion of the outer actuator member 17 toward the second end portion of the outer actuator member 17. The second guide groove 17b may extend spirally from the first guide groove 17a toward the second end portion of the outer actuator member 17. The first guide groove 17a and the second guide groove 17b may be formed continuously in the outer peripheral surface of the outer actuator member 17. The outer actuator member 17 may include a first section X1 in which the first guide groove 17a is formed, and a second section X2 in which the second guide groove 17b is formed. The first section X1 and the second section X2 may be arranged along a longitudinal direction of the outer actuator member 17. The plurality of first guide grooves 17a may be formed in the first section X1, the plurality of second guide grooves 17b may be connected to the plurality of first guide grooves 17a, respectively, and the plurality of second guide grooves 17b may be formed in the second section X2.

Referring to FIG. 7, the inner actuator member 51 may be releasably engaged to the cavity of the outer actuator member 17 through the friction fastener 60. The inner actuator member 51 may include a first end portion facing the exterior of the vehicle, and a second end portion facing the interior of the vehicle. The friction fastener 60 may be configured to allow the outer actuator member 17 and the inner actuator member 51 to be frictionally engaged and disengaged.

Referring to FIG. 12, the inner actuator member 51 may be a lead nut having an internal thread 51a formed therein, and the inner actuator member 51 may have a recessed portion 52 provided in the first end portion thereof. The friction fastener 60 may be mounted in the recessed portion 52 of the inner actuator member 51, and the friction fastener 60 may be press-fitted between an outer surface of the inner actuator member 51 and an inner surface of the outer actuator member 17 to allow the inner actuator member 51 and the outer actuator member 17 to be frictionally engaged and disengaged. The outer actuator member 17 and the inner actuator member 51 may be releasably engaged to each other by the friction fastener 60.

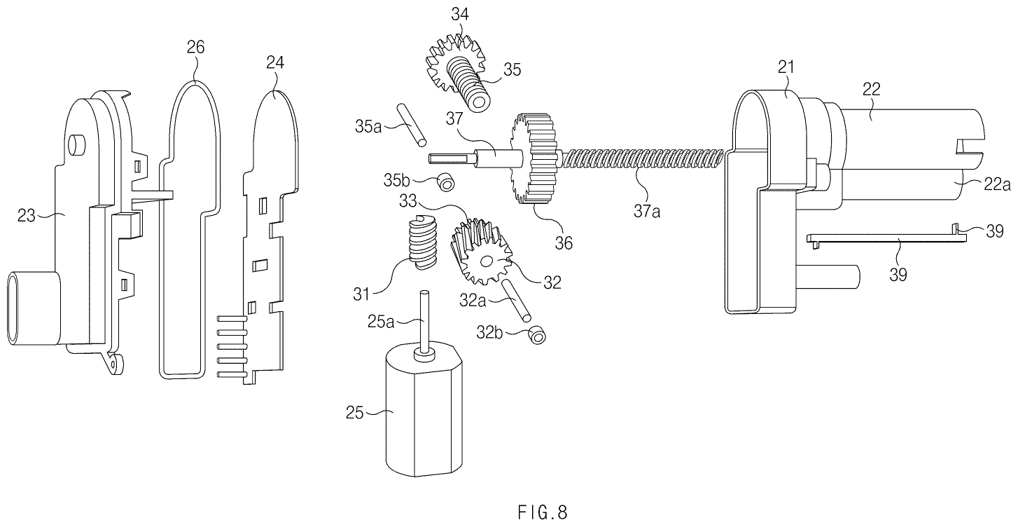

Referring to FIG. 8, the door actuator 16 may include an actuator housing 21, a motor 25 driving the inner actuator member 51, and a lead screw 37 rotated by the motor 25. The motor 25 and the lead screw 37 may be disposed in the actuator housing 21, and the inner actuator member 51 may be configured to move linearly by the rotation of the lead screw 37. The motor 25 may be a bi-directional motor rotating clockwise and counterclockwise. The lead screw 37 may have an external thread 37a on an outer peripheral surface thereof, and the lead screw 37 may extend to a predetermined length. The lead screw 37 may be configured to rotate around a central axis thereof.

Referring to FIGS. 12, 14, and 15, the internal thread 51a of the inner actuator member 51 may mesh with the external thread 37a of the lead screw 37. When the lead screw 37 is rotated by the motor 25 and a transmission mechanism 30, the inner actuator member 51 may move in a longitudinal direction of the lead screw 37. In a state in which the outer actuator member 17 is engaged to the inner actuator member 51 by the friction fastener 60, the outer actuator member 17 may move together with the inner actuator member 51 in the same direction.

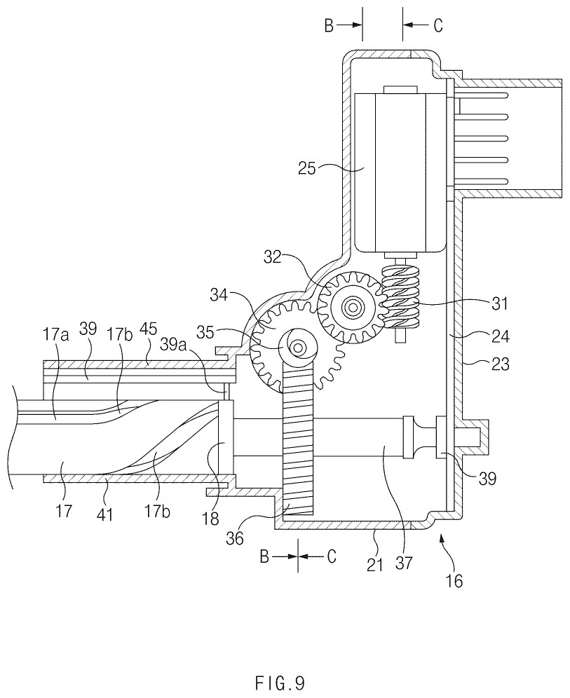

Referring to FIGS. 8 and 9, the transmission mechanism 30 may be disposed between the motor 25 and the lead screw 37. Referring to FIG. 8, the transmission mechanism 30 may be a gear train including an input gear 31 fixed to an output shaft 25a of the motor 25, a first transmission gear 32 meshing with the input gear 31, a second transmission gear 33 fixed to the first transmission gear 32, a third transmission gear 34 meshing with the second transmission gear 33, and a fourth transmission gear 35 fixed to the third transmission gear 34. As the first transmission gear 32 meshes with the input gear 31, a torque of the motor 25 may be transmitted to the first transmission gear 32, the second transmission gear 33, the third transmission gear 34, and the fourth transmission gear 35 through the input gear 31. A gear pin 32a may be inserted into the center of the first transmission gear 32 and the center of the second transmission gear 33, and an end of the gear pin 32a may be rotatably supported by a bush 32b. A gear pin 35a may be inserted into the center of the third transmission gear 34 and the center of the fourth transmission gear 35, and an end of the gear pin 35a may be rotatably supported by a bush 35b.

Referring to FIG. 9, a rotational axis of the input gear 31 may be aligned with a rotational axis of the output shaft 25a of the motor 25. A rotational axis of the first transmission gear 32 may be perpendicular to the rotational axis of the input gear 31. According to an example embodiment, the input gear 31 and the first transmission gear 32 may be a screw gear.

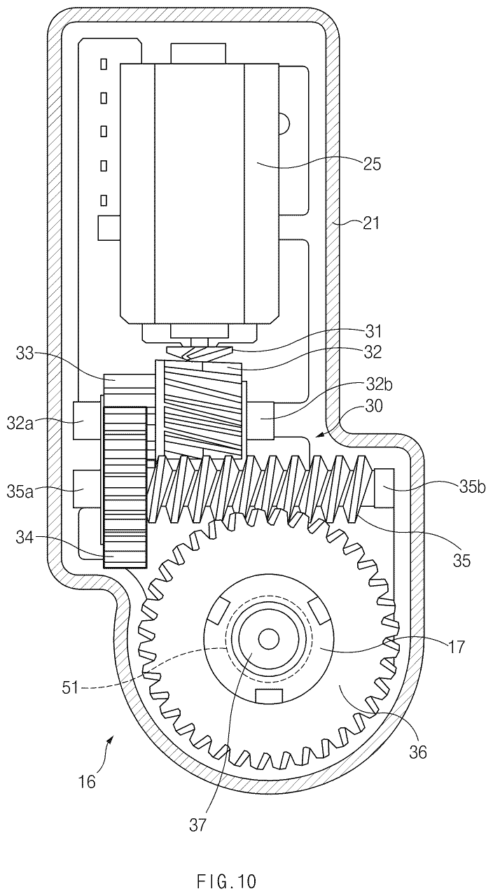

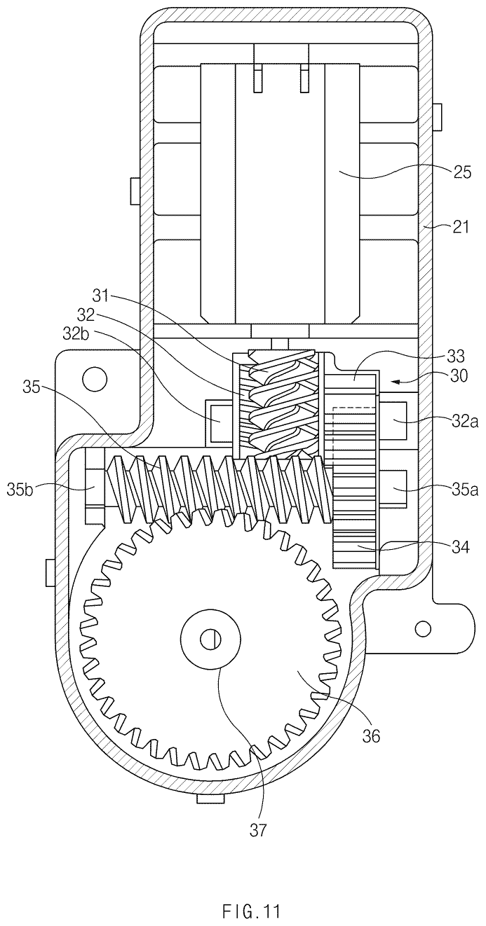

Referring to FIGS. 10 and 11, the second transmission gear 33 may be fixed to the first transmission gear 32 so that the second transmission gear 33 may rotate together with the first transmission gear 32 in the same direction. A rotational axis of the second transmission gear 33 may be aligned with the rotational axis of the first transmission gear 32. A diameter of the second transmission gear 33 may be the same as or be different from a diameter of the first transmission gear 32.

Referring to FIGS. 10 and 11, a rotational axis of the third transmission gear 34 may be parallel to the rotational axis of the second transmission gear 33. According to an example embodiment, the second transmission gear 33 and the third transmission gear 34 may be a spur gear or a helical gear.

Referring to FIGS. 10 and 11, the fourth transmission gear 35 may be fixed to the third transmission gear 34 so that the fourth transmission gear 35 may rotate together with the third transmission gear 34 in the same direction. A rotational axis of the fourth transmission gear 35 may be aligned with the rotational axis of the third transmission gear 34. A diameter of the fourth transmission gear 35 may be less than a diameter of the third transmission gear 34.

Referring to FIG. 9, the door actuator 16 may further include an operating gear 36 transmitting a torque from the transmission mechanism 30 to the lead screw 37. The operating gear 36 may be fixed to the lead screw 37 so that the lead screw 37 may rotate together with the operating gear 36 in the same direction. According to an example embodiment, the operating gear 36 and the lead screw 37 may form a unitary one-piece structure. As the operating gear 36 and the lead screw 37 form a unitary one-piece structure, vibration, shaking, and the like between the operating gear 36 and the lead screw 37 may be prevented. The operating gear 36 may be operatively connected to the transmission mechanism 30, and a rotational axis of the operating gear 36 may be aligned with a rotational axis of the lead screw 37. Specifically, the operating gear 36 may mesh with the fourth transmission gear 35 of the transmission mechanism 30, and the torque of the motor 25 may be transmitted from the transmission mechanism 30 to the operating gear 36 so that the operating gear 36 may rotate around the rotational axis thereof, and the lead screw 37 may rotate together with the operating gear 36 in the same direction.

According to an example embodiment, a central axis of the operating gear 36 may be perpendicular to a central axis of the fourth transmission gear 35, the fourth transmission gear 35 may be a worm gear, and the operating gear 36 meshing with the fourth transmission gear 35 may be a worm wheel.

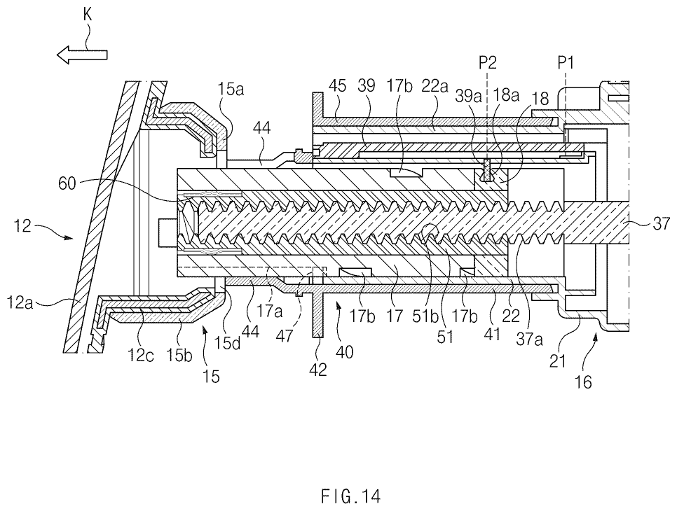

The second end portion of the inner actuator member 51 may face the actuator housing 21 of the door actuator 16. Referring to FIGS. 12 and 14, as the inner actuator member 51 moves by the rotation of the lead screw 37, the second end portion of the inner actuator member 51 may move close to or move away from the operating gear 36.

Referring to FIG. 8, a cover 23 may be joined to the actuator housing 21 by a plurality of snap fittings, and the actuator housing 21 and the cover 23 may define a cavity. A seal 26 may be interposed between edges of the actuator housing 21 and edges of the cover 23 so that the actuator housing 21 and the cover 23 may be sealed by the seal 26. A printed circuit board (PCB) 24, the motor 25, the transmission mechanism 30, and the lead screw 37 may be disposed in the cavity defined by the actuator housing 21 and the cover 23.

When a frictional force between the friction fastener 60 and the outer actuator member 17 can be greater than an external force acting between the friction fastener 60 and the outer actuator member 17, the friction fastener 60 may allow the outer actuator member 17 and the inner actuator member 51 to be frictionally engaged. When the frictional force between the friction fastener 60 and the outer actuator member 17 is less than the external force acting between the friction fastener 60 and the outer actuator member 17, the friction fastener 60 may allow the outer actuator member 17 and the inner actuator member 51 to be frictionally disengaged (or allowing relative movement between the inner actuator member 51 and the outer actuator member 17). Referring to FIG. 12, the friction fastener 60 may have a plurality of projections 61 protruding in an outer diameter direction thereof, and the plurality of projections 61 may be spaced apart from each other at a predetermined pitch in a circumferential direction. An inner surface of the friction fastener 60 may be frictionally engaged to the outer surface of the inner actuator member 51, and the plurality of projections 61 may be frictionally engaged to the inner surface of the outer actuator member 17. The friction fastener 60 may include a corrugated metal strip 62 and a polymer layer 63 attached to an outer surface of the metal strip 62. The metal strip 62 may frictionally contact the outer surface of the inner actuator member 51, and the polymer layer 63 may frictionally contact the inner surface of the outer actuator member 17. The polymer layer 63 may have a coefficient of friction lower than that of the metal strip 62. The metal strip 62 may be made of a stainless steel material, and the polymer layer 63 may be made of polytetrafluoroethylene (PTFE).

The torque of the motor 25 may be set to be less than the frictional force between the projections 61 of the friction fastener 60 and the inner surface of the outer actuator member 17, and accordingly the inner surface of the outer actuator member 17 and the outer surface of the inner actuator member 51 may be maintained to be engaged by the frictional force of the friction fastener 60. As the torque of the motor 25 is transmitted to the input gear 31, the first transmission gear 32, the second transmission gear 33, the third transmission gear 34, the fourth transmission gear 35, the operating gear 36, and the lead screw 37, the lead screw 37 may rotate, the inner actuator member 51 may move in the longitudinal direction of the lead screw 37 by the rotation of the lead screw 37, and the outer actuator member 17 may move together with the inner actuator member 51 in the same direction.

When the door 12 is not electrically opened and closed by the door actuator 16 due to battery discharge, a failure of the door actuator 16, and the like, the user may manually open and close the door 12. When the user manually opens and closes the door 12, an external force applied by the user to the door 12 may be transmitted to the outer actuator member 17, and the outer actuator member 17 may linearly move and rotate together with the door 12. When the external force transmitted from the outer actuator member 17 to the inner actuator member 51 is greater than the frictional force between the projections 61 of the friction fastener 60 and the inner surface of the outer actuator member 17, slipping may occur between the projections 61 of the friction fastener 60 and the outer actuator member 17. Because the inner surface of the outer actuator member 17 is disengaged from the outer surface of the inner actuator member 51, the outer actuator member 17 may move relative to the inner actuator member 51, the inner actuator member 51 and the operating gear 36 may not move, and the motor 25 and the transmission mechanism 30 may not operate. When the user manually opens and closes the door 12, the external force applied to the outer actuator member 17 may not be transmitted to the inner actuator member 51, the transmission mechanism 30, and the motor 25 so that overload may be blocked from being transmitted to the motor 25.

Referring to FIG. 12, the door actuator 16 may include a guide sleeve 22 extending to a predetermined length from the actuator housing 21. The guide sleeve 22 may include a first end portion facing the exterior of the vehicle, and a second end portion facing the interior of the vehicle. The first end portion of the guide sleeve 22 may face the door 12, and the second end portion of the guide sleeve 22 may be integrally connected to the actuator housing 21. Referring to FIGS. 12, 14, and 15, the guide sleeve 22 may extend from the actuator housing 21 toward the door 12, the outer actuator member 17 and the inner actuator member 51 may be movably received in the guide sleeve 22, and the guide sleeve 22 may be configured to guide the linear movement and rotation of the outer actuator member 17 and the inner actuator member 51. The outer actuator member 17 may have a cylindrical shape with a predetermined outer diameter, and the guide sleeve 22 may have a cylindrical shape with an inner diameter corresponding to the outer diameter of the outer actuator member 17. Because the outer diameter of the outer actuator member 17 is slightly less than or equal to the inner diameter of the guide sleeve 22, the outer surface of the outer actuator member 17 may match an inner surface of the guide sleeve 22. Accordingly, while the outer actuator member 17 is moving and rotating in the guide sleeve 22, vibration, shaking, and the like may be prevented.

According to an example embodiment of the present disclosure, as the operating gear 36 can be fixed to the lead screw 37, the outer actuator member 17 and the inner actuator member 51 may be assembled with the lead screw 37, and then the outer actuator member 17, the inner actuator member 51, and the lead screw 37 may be assembled with the actuator housing 21. Thereafter, the attachment portion 15 of the outer actuator member 17 may be attached to the inner panel 12b of the door 12. As described above, the outer actuator member 17, the inner actuator member 51, and the lead screw 37 may be preassembled, and the outer actuator member 17, the inner actuator member 51, and the lead screw 37 may be assembled with the actuator housing 21, and then the outer actuator member 17 may be assembled with the door 12 so that an assembly process thereof may not only be simplified but also be smoothly and stably performed.

The charge port door system 10 according to an example embodiment of the present disclosure may include a guide housing 40 configured to receive the guide sleeve 22 and the outer actuator member 17. The guide housing 40 may extend through an opening of the housing 11, and the guide housing 40 may be fixed to the housing 11. The guide housing 40 may include a first end portion facing the exterior of the vehicle, and a second end portion facing the interior of the vehicle. The outer actuator member 17 may be received in the guide sleeve 22 of the door actuator 16, the guide sleeve 22 may be received in the guide housing 40, and the guide housing 40 may be fixed to the housing 11 so that support stiffness of the outer actuator member 17 and the door 12 may be improved, and accordingly the door 12 may be stably supported against various adverse conditions and any external shocks.

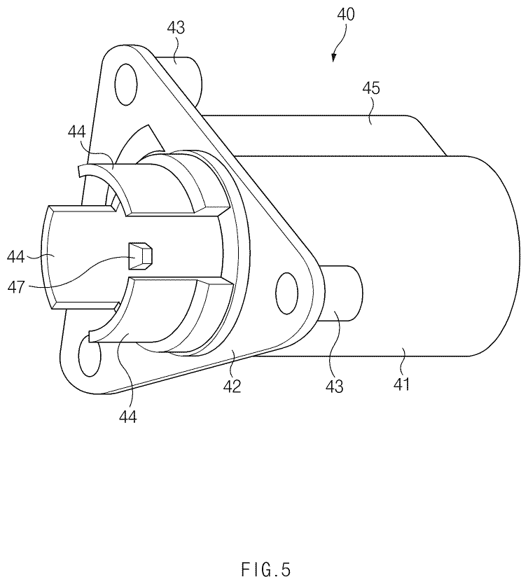

Referring to FIG. 5, the guide housing 40 may include a cylindrical portion 41, an attachment plate 42 provided on the cylindrical portion 41, and a plurality of bosses 43 provided on the attachment plate 42.

The cylindrical portion 41 may include a first end portion facing the exterior of the vehicle, and a second end portion facing the interior of the vehicle. The cylindrical portion 41 may extend through the opening of the housing 11, and the cylindrical portion 41 may be configured to receive the guide sleeve 22 of the door actuator 16. As the guide sleeve 22 of the actuator housing 21 is received in the cylindrical portion 41 of the guide housing 40, the outer actuator member 17 and the inner actuator member 51 may move and rotate through the guide sleeve 22 and the guide housing 40.

The attachment plate 42 may be fixed to the interior surface of the housing 11 through the plurality of bosses 43.

The plurality of bosses 43 may be provided on edges of the attachment plate 42, and the plurality of bosses 43 may protrude from the attachment plate 42 toward the interior of the vehicle. A fastener such as a screw may be screwed into each boss 43 so that the attachment plate 42 of the guide housing 40 may be fixed to the interior surface of the housing 11. The attachment plate 42 of the guide housing 40 may be firmly fixed to the housing 11 through the plurality of bosses 43 so that vibration, shaking, damage, and the like of the actuator members may be prevented while the outer actuator member 17 and the inner actuator member 51 are moving.

Referring to FIGS. 5, 7, and 13, the guide housing 40 may have guide projections 47 provided on an inner surface thereof, and each guide projection 47 may protrude from an inner surface of the cylindrical portion 41 toward the center of the cylindrical portion 41. The guide projection 47 may be received in the first guide groove 17a and the second guide groove 17b of the outer actuator member 17. Accordingly, the linear movement and rotation of the outer actuator member 17 may be guided by the guide projections 47 and the guide grooves 17a and 17b. According to an example embodiment, the guide projections 47 may be provided at the first end portion of the cylindrical portion 41 of the guide housing 40, and accordingly the guide projections 47 and the guide grooves 17a and 17b may guide the linear movement and rotation of the outer actuator member 17 over the entire length of the outer actuator member 17.

Referring to FIG. 5, the guide housing 40 may have a plurality of support projections 44 protruding from the first end portion of the cylindrical portion 41 toward the exterior of the vehicle. Each support projection 44 may have an arc shape, and the plurality of support projections 44 may be spaced apart from each other in a circumferential direction of the cylindrical portion 41. Referring to FIG. 7, the support projections 44 of the guide housing 40 may be inserted into or released from the openings 15d of the attachment portion 15 of the outer actuator member 17, respectively.

Referring to FIG. 14, in a state in which the outer actuator member 17 is engaged to the inner actuator member 51 by the friction fastener 60, the inner actuator member 51 may move in the longitudinal direction of the lead screw 37 by the rotation of the lead screw 37 so that the outer actuator member 17 may move together with the inner actuator member 51 in the same direction. While the outer actuator member 17 is moving by the rotation of the lead screw 37 and the linear movement of the inner actuator member 51, the first guide groove 17a of the outer actuator member 17 may be guided by the guide projection 47 of the guide housing 40 so that the outer actuator member 17 may move linearly along the first guide groove 17a. That is, when the lead screw 37 is rotated, and the outer actuator member 17 is guided by the first guide groove 17a and the guide projection 47, the outer actuator member 17 may move forward or backward in the longitudinal direction of the lead screw 37.

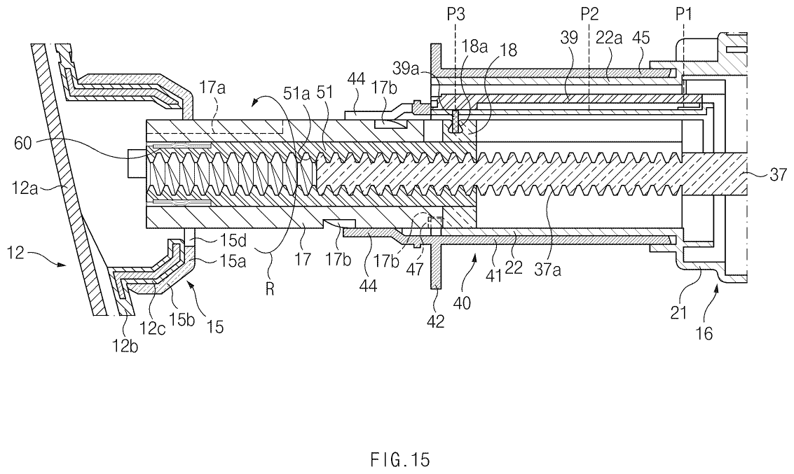

Referring to FIG. 15, in a state in which the outer actuator member 17 is engaged to the inner actuator member 51 by the friction fastener 60, the inner actuator member 51 may move in the longitudinal direction of the lead screw 37 by the rotation of the lead screw 37 so that the outer actuator member 17 may move together with the inner actuator member 51. While the outer actuator member 17 is moving by the rotation of the lead screw 37 and the linear movement of the inner actuator member 51, the outer actuator member 17 may be guided by the second guide groove 17b and the guide projection 47 so that the outer actuator member 17 may move (rotate) spirally along the second guide groove 17b. As the rotation of the outer actuator member 17 is guided by the second guide groove 17b and the guide projection 47, the outer actuator member 17 may rotate around the central axis thereof.

In a state in which the outer actuator member 17 is engaged to the inner actuator member 51 by the friction fastener 60, the outer actuator member 17 and the inner actuator member 51 may be configured to move by the rotation of the lead screw 37 between a first position (see P1 of FIG. 12), a second position (see P2 of FIG. 14), and a third position (see P3 of FIG. 15). In a state in which the outer actuator member 17 is engaged to the inner actuator member 51 by the friction fastener 60, when the outer actuator member 17 and the inner actuator member 51 move between the first position P1 and the second position P2, the outer actuator member 17 may be linearly guided by the guide projection 47 and the first guide groove 17a. In a state in which the outer actuator member 17 is engaged to the inner actuator member 51 by the friction fastener 60, when the outer actuator member 17 and the inner actuator member 51 move between the second position P2 and the third position P3, the outer actuator member 17 may be guided to rotate around the central axis thereof by the guide projection 47 and the second guide groove 17b.

Referring to FIG. 6, the outer actuator member 17 may include a stopper 18 configured to restrict the movement of the outer actuator member 17. The stopper 18 may be fixed to the second end portion of the outer actuator member 17, and the stopper 18 may have an annular recessed portion 18a provided in an outer peripheral surface thereof. When the outer actuator member 17 moves to the third position, the stopper 18 may prevent the outer actuator member 17 from being released from the guide sleeve 22 and the guide housing 40. When the outer actuator member 17 moves forward to the third position, the stopper 18 may be stopped by the guide projection 47 to thereby prevent the outer actuator member 17 from being released from the guide sleeve 22.

Referring to FIG. 8, the door actuator 16 may further include a sensor 39 configured to detect the position of the door 12. The door actuator 16 may have a sensor receiving portion 22a integrally connected to the guide sleeve 22. Referring to FIGS. 12, 14, and 15, the sensor 39 may extend in a longitudinal direction of the guide sleeve 22, and be received in the sensor receiving portion 22a. The sensor 39 may sense the position of the outer actuator member 17 to detect the position of the door 12. Referring to FIG. 5, the guide housing 40 may have a cover portion 45 integrally connected to the cylindrical portion 41, and the cover portion 45 may extend in a longitudinal direction of the cylindrical portion 41. Referring to FIG. 12, the cover portion 45 may cover the sensor receiving portion 22a.

Referring to FIGS. 12, 14, and 15, the sensor 39 may include a tip 39a which is movable in a longitudinal direction thereof. A free end of the tip 39a may be fitted into the recessed portion 18a of the stopper 18 so that the tip 39a may be connected to the stopper 18. When the outer actuator member 17 moves and rotates, the tip 39a of the sensor 39 may move together with the outer actuator member 17. The sensor 39 may be configured to sense whether the stopper 18 of the outer actuator member 17 is in the first position P1, the second position P2, or the third position P3. A controller (not shown) may be configured to accurately detect the position of the door 12 based on the position of the outer actuator member 17 sensed by the sensor 39.

Referring to FIGS. 12, 16, and 17, when the outer actuator member 17 is in the first position P1, the door 12 may be in the cover position and the retracted position so that the door 12 may be fully closed to cover the housing 11. Referring to FIGS. 14 and 18, when the outer actuator member 17 is in the second position P2, the door 12 may be in the cover position and the advanced position so that the door 12 may move forward from the housing 11 toward the outside of the vehicle, and accordingly the door 12 may be spaced apart from the housing 11. Referring to FIGS. 15, 19, and 20, when the outer actuator member 17 is in the third position P3, the door 12 may be in the uncover position to uncover the housing 11, and accordingly the door 12 may be opened.

As the motor 25 rotates, the torque of the motor 25 may be transmitted to the operating gear 36 and the lead screw 37 through the transmission mechanism 30. As the operating gear 36 and the lead screw 37 rotate, the inner actuator member 51 and the outer actuator member 17 may move in the longitudinal direction of the lead screw 37.

Referring to FIG. 12, when the outer actuator member 17 is in the first position P1, the second end portion of the outer actuator member 17 may move close to the actuator housing 21, and the first end portion of the outer actuator member 17 may be aligned with the first end portion of the guide sleeve 22 of the actuator housing 21. When the outer actuator member 17 is in the first position P1, the entire edge of the door 12 may contact the seal 13 of the housing 11 as illustrated in FIGS. 16 and 17 so that the door 12 and the housing 11 may be sealed, and the door 12 may be fully closed to cover the housing 11.

When the user presses the door 12 in a state in which the door 12 is closed, the door 12 may press the opening button 14b, and the operating gear 36 and the lead screw 37 may rotate in a first direction by the motor 25 and the transmission mechanism 30 so that the inner actuator member 51 and the outer actuator member 17 may move forward in the longitudinal direction of the lead screw 37 toward the outside of the vehicle (see the direction of arrow K in FIG. 14). Referring to FIG. 14, when the inner actuator member 51 and the outer actuator member 17 move forward by the rotation of the lead screw 37, the first guide groove 17a of the outer actuator member 17 may be linearly guided by the guide projection 47 of the guide housing 40 so that the inner actuator member 51 and the outer actuator member 17 may move linearly along the first guide groove 17a toward the outside of the vehicle, and accordingly the inner actuator member 51 and the outer actuator member 17 may be in the second position P2. When the outer actuator member 17 is in the second position P2, the second end portion of the outer actuator member 17 may move forward from the actuator housing 21, and the first end portion of the outer actuator member 17 may move forward from the first end portion of the guide sleeve 22 of the actuator housing 21 toward the outside of the vehicle. As the door 12 moves forward together with the outer actuator member 17, the door 12 may be advanced from the housing 11 toward the outside of the vehicle by a predetermined distance. When the outer actuator member 17 is in the second position P2, the door 12 may be advanced from the housing 11 toward the outside of the vehicle as illustrated in FIG. 18, and the entire edge of the door 12 may be spaced apart from the seal 13 of the housing 11 by a predetermined distance S.

Referring to FIG. 15, as the operating gear 36 and the lead screw 37 continuously rotate in the first direction by the motor 25 and the transmission mechanism 30 in a state in which the inner actuator member 51 and the outer actuator member 17 are in the second position P2, the inner actuator member 51 and the outer actuator member 17 may move from the second position P2 toward the third position P3 by the rotation of the lead screw 37. When the outer actuator member 17 moves from the second position P2 to the third position P3, the second guide groove 17b of the outer actuator member 17 may be guided by the guide projection 47 of the guide housing 40 so that the outer actuator member 17 may move forward spirally along the second guide groove 17b toward the outside of the vehicle. Accordingly, the outer actuator member 17 may rotate around the central axis thereof (see the direction of arrow R in FIGS. 15 and 20). As illustrated in FIG. 20, as the door 12 rotates to the uncover position, the door 12 may be opened.

Referring to FIG. 12, when the outer actuator member 17 is in the first position, the support projections 44 of the guide housing 40 may be inserted into the openings 15d of the attachment portion 15. In a state in which the door 12 is closed, the door 12 may be stably supported by the support projections 44 of the guide housing 40 and the openings 15d of the attachment portion 15. Referring to FIGS. 14 and 15, when the outer actuator member 17 is in the second position and the third position, the support projections 44 of the guide housing 40 may be released from the openings 15d of the attachment portion 15, and accordingly the opening of the door 12 may be stably performed.

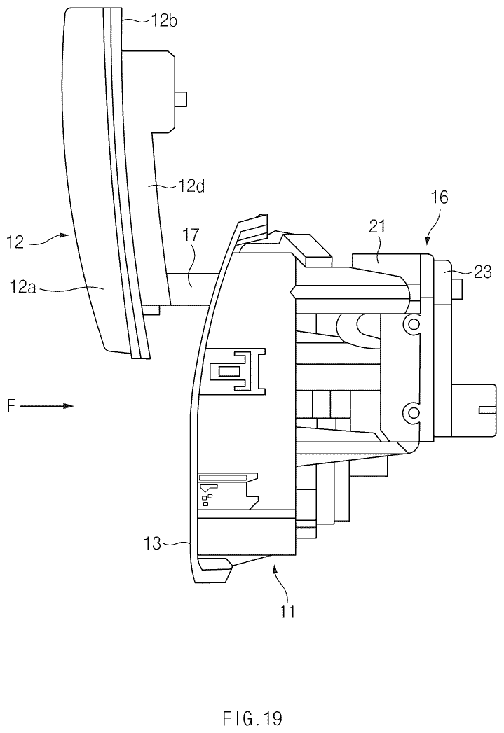

As illustrated in FIGS. 19 and 20, when the user presses the closing button 14c in a state in which the door 12 is opened, the operating gear 36 and the lead screw 37 may rotate in a second direction opposite to the first direction by the motor 25 and the transmission mechanism 30, and the inner actuator member 51 and the outer actuator member 17 may move from the third position to the second position. When the outer actuator member 17 moves from the third position to the second position, the second guide groove 17b of the outer actuator member 17 may be guided by the guide projection 47 of the guide housing 40 so that the outer actuator member 17 may move backward spirally along the second guide groove 17b toward the second position. Accordingly, the outer actuator member 17 may rotate around the central axis thereof (see the direction opposite to the direction of arrow R in FIG. 15), and the door 12 may rotate to the cover position. As the operating gear 36 and the lead screw 37 continuously rotate in the second direction by the motor 25 and the transmission mechanism 30 in a state in which the inner actuator member 51 and the outer actuator member 17 are in the second position, the inner actuator member 51 and the outer actuator member 17 may move from the second position toward the first position by the rotation of the lead screw 37. When the outer actuator member 17 moves from the second position to the first position, the first guide groove 17a of the outer actuator member 17 may be continuously guided by the guide projection 47 of the guide housing 40 so that the outer actuator member 17 may move from the second position to the first position. When the outer actuator member 17 moves from the second position to the first position, the outer actuator member 17 may be linearly guided to the first position by the guide projection 47 and the first guide groove 17a. As the door 12 moves to the retracted position, the door 12 may come into contact with the seal 13 of the housing 11, and the door 12 may be fully closed.

As set forth above, the charge port door system according to example embodiments of the present disclosure may be designed to allow the door to move by the door actuator between the cover position in which the door covers the housing and the uncover position in which the door uncovers the housing. Here, the door in the cover position may be configured to move between the retracted position in which the door comes into contact with the housing and the advanced position in which the door is advanced from the housing so that the opening and closing of the door may be smoothly performed in a narrow space. In addition, in a state in which the door is opened, the charging plug may be prevented from interfering with the door.

According to example embodiments of the present disclosure, when the frictional force between the friction fastener and the outer actuator member is greater than the external force acting between the friction fastener and the outer actuator member, the friction fastener may allow the outer actuator member and the inner actuator member to be frictionally engaged. Accordingly, as the lead screw is rotated by the motor of the door actuator, the outer actuator member may move together with the inner actuator member in the same direction.

According to example embodiments of the present disclosure, when the frictional force between the friction fastener and the outer actuator member is less than the external force acting between the friction fastener and the outer actuator member, the friction fastener may allow the outer actuator member and the inner actuator member to be frictionally disengaged. Accordingly, the outer actuator member may move together with the door, and the door may be opened and closed manually.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

What is claimed is:

1. A charge port door system, comprising:
a housing;
a door configured to rotate between a cover position in which the door covers the housing and an uncover position in which the door uncovers the housing, and to move between a retracted position in which the door comes into contact with the housing and an advanced position in which the door is advanced outward from the housing in a state in which the door is in the cover position;
a door actuator fixed to the door, wherein the door actuator comprises an outer actuator member configured to linearly move and rotate by a motor, and an inner actuator member releasably engaged to the outer actuator member by a friction fastener; and
a guide housing fixed to the housing, and configured to receive the outer actuator member,
wherein the outer actuator member includes a first guide groove extending straightly along a longitudinal direction thereof, and a second guide groove extending spirally from the first guide groove,
wherein the first guide groove and the second guide groove are provided in an outer-actuator-member outer surface of the outer actuator member, and
wherein the guide housing comprises a guide projection configured to be received in the first guide groove and the second guide groove.

2. The charge port door system according to claim 1, wherein the door actuator further comprises a lead screw configured to be rotated by the motor,
wherein the lead screw includes an external thread on an outer peripheral surface thereof, and
wherein the inner actuator member includes an internal thread meshing with the external thread of the lead screw.

3. The charge port door system according to claim 2, wherein the friction fastener is press-fitted between an inner-actuator-member outer surface of the inner actuator member and an inner surface of the outer actuator member, and
wherein the friction fastener includes a projection frictionally engaged to the inner surface of the outer actuator member.

4. The charge port door system according to claim 3, wherein the friction fastener includes a metal strip having a corrugated shape, and a polymer layer attached to a metal-strip outer surface of the metal strip,
wherein the polymer layer frictionally contacts the inner surface of the outer actuator member, and
wherein the metal strip frictionally contacts the inner-actuator-member outer surface of the inner actuator member.

5. The charge port door system according to claim 4, wherein the polymer layer has a coefficient of friction lower than that of the metal strip.

6. The charge port door system according to claim 1, wherein the outer actuator member includes an attachment portion fixed to the door.

7. The charge port door system according to claim 1, wherein the outer actuator member is configured to move between a first position, a second position, and a third position,
such that the door is in the retracted position in response to the outer actuator member being in the first position,
such that the door is in the advanced position in response to the outer actuator member being in the second position, and
such that the door is in the uncover position in response to the outer actuator member being in the third position.

8. The charge port door system according to claim 7, wherein, in response to the outer actuator member moving between the first position and the second position, the outer actuator member is linearly guided by the first guide groove and the guide projection, and
wherein, in response to the outer actuator member moving between the second position and the third position, the outer actuator member is guided to rotate around a central axis thereof by the second guide groove and the guide projection.

9. The charge port door system according to claim 1, wherein the door actuator further comprises an actuator housing receiving the motor, and a guide sleeve extending from the actuator housing toward the door,
wherein the guide sleeve is received in the guide housing, and
wherein the outer actuator member is movably received in the guide sleeve.

10. The charge port door system according to claim 9, wherein the outer-actuator-member outer surface of the outer actuator member is configured to match an inner surface of the guide sleeve.

11. The charge port door system according to claim 9, wherein the guide housing comprises:
a cylindrical portion receiving the guide sleeve;
an attachment plate provided on the cylindrical portion; and
a plurality of bosses provided on the attachment plate, wherein the plurality of bosses are fixed to the door by a plurality of fasteners.

12. The charge port door system according to claim 2, wherein the door actuator further comprises a transmission mechanism configured to transmit a torque of the motor to the lead screw.

13. The charge port door system according to claim 12, wherein the door actuator further comprises an operating gear configured to transmit the torque from the transmission mechanism to the lead screw.

14. The charge port door system according to claim 13, wherein the operating gear is fixed to the lead screw.

15. The charge port door system according to claim 1, wherein the door actuator further comprises a sensor configured to sense an outer-actuator-member position of the outer actuator member to detect a door position of the door.

16. A charge port door system comprising:
a housing;
a guide housing fixed to the housing, wherein the guide housing includes a guide projection;
a door configured to cover a portion of the housing; and
a door actuator movably coupling the door to the housing, wherein the door actuator comprises:
an electric motor,
an inner actuator member including an internal threaded portion,
an outer actuator member including a first guide groove extending straightly along a longitudinal direction thereof, and a second guide groove extending spirally from the first guide groove,
wherein the guide projection is configured to be received in the first guide groove and the second guide groove, and
wherein the guide housing is configured to receive the outer actuator member therein with a configuration such that the outer actuator member can translate linearly within and rotate within the guide housing while having an outer-actuator-member motion of the outer actuator member being guided by the guide projection in and along the first guide groove and the second guide groove during the outer-actuator-member motion,
a lead screw including an external threaded portion on an outer peripheral surface thereof, wherein the lead screw is rotatably coupled to the electric motor and configured to be rotated by the electric motor, wherein the internal threaded portion of the inner actuator member meshes with and threadedly engages with the external threaded portion of the lead screw, and
a friction fastener disposed between the outer actuator member and the inner actuator member in configuration to provide frictional engagement between the outer actuator member and the inner actuator member,
wherein the charge port door system is configured such that rotation of the lead screw by the electric motor can cause an inner-actuator-member motion of the inner actuator member, whereby the inner-actuator-member motion of the inner actuator member can drive the outer-actuator-member motion of the outer actuator member, whereby the door can move between a first retracted cover position, a second partially-outwardly-extended cover position, and a third rotated-outwardly-extended uncover position, wherein the housing is covered and sealed by the door in the first retracted cover position of the door, and wherein the housing is exposed and accessible in the third rotated-outwardly-extended uncover position of the door, and wherein the door is pivoted relative to the housing in the third rotated-outwardly-extended uncover position.

17. The charge port door system according to claim 16, wherein the friction fastener is press-fitted between an inner-actuator-member outer surface of the inner actuator member and an inner surface of the outer actuator member, and
wherein the friction fastener includes a projection frictionally engaged to the inner surface of the outer actuator member.

18. The charge port door system according to claim 17, wherein the friction fastener includes a metal strip having a corrugated shape, and a polymer layer attached to a metal-strip outer surface of the metal strip,
wherein the polymer layer frictionally contacts the inner surface of the outer actuator member,
wherein the metal strip frictionally contacts the inner-actuator-member outer surface of the inner actuator member, and
wherein the polymer layer has a coefficient of friction lower than that of the metal strip.

19. The charge port door system according to claim 16, wherein the door actuator further comprises a sensor configured to sense an outer-actuator-member position of the outer actuator member to detect a door position of the door.

20. A charge port door system, comprising:
a housing;
a door configured to rotate between a cover position in which the door covers the housing and an uncover position in which the door uncovers the housing, and to move between a retracted position in which the door comes into contact with the housing and an advanced position in which the door is advanced outward from the housing in a state in which the door is in the cover position;
a door actuator fixed to the door, wherein the door actuator comprises an outer actuator member configured to linearly move and rotate by a motor, and an inner actuator member releasably engaged to the outer actuator member by a friction fastener; and
a guide housing fixed to the housing, and configured to receive the outer actuator member,
wherein the outer actuator member includes a first guide groove extending straightly along a longitudinal direction thereof, and a second guide groove extending spirally from the first guide groove,
wherein the first guide groove and the second guide groove are provided in an outer-actuator-member outer surface of the outer actuator member, and
wherein the guide housing comprises a guide projection configured to be received in the first guide groove and the second guide groove,
wherein the door actuator further comprises a lead screw configured to be rotated by the motor,
wherein the lead screw includes an external thread on an outer peripheral surface thereof,
wherein the inner actuator member includes an internal thread meshing with the external thread of the lead screw,
wherein the friction fastener is press-fitted between an inner-actuator-member outer surface of the inner actuator member and an inner surface of the outer actuator member,
wherein the friction fastener includes a projection frictionally engaged to the inner surface of the outer actuator member,
wherein the friction fastener includes a metal strip having a corrugated shape, and a polymer layer attached to a metal-strip outer surface of the metal strip,
wherein the polymer layer frictionally contacts the inner surface of the outer actuator member,
wherein the metal strip frictionally contacts the inner-actuator-member outer surface of the inner actuator member,
wherein the polymer layer has a coefficient of friction lower than that of the metal strip,
wherein the outer actuator member includes an attachment portion fixed to the door,
wherein the outer actuator member is configured to move between a first position, a second position, and a third position,
such that the door is in the retracted position in response to the outer actuator member being in the first position,
such that the door is in the advanced position in response to the outer actuator member being in the second position, and
such that the door is in the uncover position in response to the outer actuator member being in the third position,
wherein, in response to the outer actuator member moving between the first position and the second position, the outer actuator member is linearly guided by the first guide groove and the guide projection,
wherein, in response to the outer actuator member moving between the second position and the third position, the outer actuator member is guided to rotate around a central axis thereof by the second guide groove and the guide projection,
wherein the door actuator further comprises an actuator housing receiving the motor, and a guide sleeve extending from the actuator housing toward the door,
wherein the guide sleeve is received in the guide housing,
wherein the outer actuator member is movably received in the guide sleeve,
wherein the outer-actuator-member outer surface of the outer actuator member is configured to match an inner surface of the guide sleeve,
wherein the guide housing comprises:
a cylindrical portion receiving the guide sleeve,
an attachment plate provided on the cylindrical portion, and
a plurality of bosses provided on the attachment plate, wherein the plurality of bosses are fixed to the door by a plurality of fasteners,
wherein the door actuator further comprises a transmission mechanism configured to transmit a torque of the motor to the lead screw,
wherein the door actuator further comprises an operating gear configured to transmit the torque from the transmission mechanism to the lead screw,
wherein the operating gear is fixed to the lead screw, and
wherein the door actuator further comprises a sensor configured to sense an outer-actuator-member position of the outer actuator member to detect a door position of the door.
